(19) United States
(12) Patent Application Publication
(10) Pub. No.: US 2011/0121194 A1
(43) Pub. Date: May 26, 2011

(54) CONTROLLED TRANSPORT SYSTEM FOR AN ELLIPTIC CHARGED-PARTICLE BEAM

(76) Inventors: Ronak J. Bhatt, Cypress, TX (US); Chiping Chen, Needham, MA (US); Jing Zhou, Woburn, MA (US)

(21) Appl. No.: 11/873,075

(22) Filed: Oct. 16, 2007

Related U.S. Application Data
(60) Provisional application No. 60/852,037, filed on Oct. 16, 2006.

(51) Int. Cl. H01J 1/50

(52) U.S. Cl. 250/396 ML

(57) ABSTRACT

A charged-particle beam control system includes a plurality of external magnets that generate an axially-varying longitudinal magnetic (AVLM)/axially-varying quadrupole magnetic (AVQM) field. A plurality of external electrode geometries generates an axially-varying longitudinal electrostatic (AVLE)/axially-varying quadrupole electrostatic (AVQE) field. The external electrode geometries and magnets control and confine a charged-particle beam of elliptic cross-section.

### PRIORITY INFORMATION

This application claims priority from provisional application Ser. No. 60/852,037 filed Oct. 16, 2006, which is incorporated herein by reference in its entirety.

### BACKGROUND OF THE INVENTION

The invention relates to the field of charged-particle beam systems, and in particular to an elliptic charged-particle beam system with an end-to-end controlled beam profile.

High-intensity, large aspect-ratio elliptic beams are of great interest because of their applications in particle accelerators and vacuum electron devices, but their inherent three-dimensional (3D) nature presents significant theoretical, design, and experimental challenges in the development of elliptic beam systems. The traditional approach to charged-particle dynamics problems involves extensive numerical optimization over the space of initial and boundary conditions in order to obtain desired charged-particle trajectories. For a 3D system, such as an elliptic charged-particle beam, the traditional approach is numerically cumbersome and will not obtain a globally-optimum solution. As a result, beam systems designed using these approaches will result in a degradation of beam brightness, increased noise, particle loss, and reduced efficiency.

An essential component of charged-particle beam systems is the beam diode, consisting of a charged-particle emitter and an electrostatic gap across which one or more electrostatic potential differences are maintained. The potential differences accelerate the emitted charged particles, forming a beam which exits the diode through a hole and then enters a beam transport tunnel. In order to counteract electrostatic defocusing effects caused by the diode hole, beam designers compensate by constructing the diode and emitter such that the beam is initially convergent. This compensation, however, creates beam density nonuniformity and contributes to a degradation of beam brightness.

A second essential component of charged-particle beam systems is the beam transport tunnel. In the transport tunnel, combinations of magnetic and electrostatic fields are used to focus a beam such that it maintains (usually) parallel flow. If the proper focusing field structure is not applied, the beam can undergo envelope oscillations which contribute to beam brightness degradation and particle loss.

A third essential component of many charged-particle beam systems is the depressed collector placed at the end of the beam transport tunnel to collect the remaining energy in the beam. A well-designed depressed collector minimizes the waste heat generated by the impacting beam while maximizing the electrical energy recovered from said beam. Modern high-efficiency multiple-stage depressed collectors (complicated structures with multiple electrodes held at different potentials) can obtain collection efficiencies approaching 90%.

A fourth essential component of many charged-particle beam systems is a beam compression/expansion system. In order to concentrate high-current beams through small beam tunnels, beams are often compressed in their transverse dimensions (either electrostatically or magnetically) in the beam-generating diode prior to entering the beam tunnel. Similarly, to minimize damage to a collector at the end of a beam system, charged-particle beams are often expanded in their transverse dimension in order to deposit the beam energy over a larger surface on the collector.

### SUMMARY OF THE INVENTION

According to one aspect of the invention, there is provided a charged-particle beam control system. The charged-particle beam control system includes a plurality of external magnets that generate an axially-varying longitudinal magnetic (AVLM)/axially-varying quadrupole magnetic (AVQM) field. A plurality of external electrode geometries generates an axially-varying longitudinal electrostatic (AVLE)/axially-varying quadrupole electrostatic (AVQE) field. The external electrode geometries and magnets control and confine a charged-particle beam of elliptic cross-section. A depressed collector collects the charged-particle beam. The depressed collector includes one or more electrodes, and a collection surface onto which a beam impacts. The electrodes and collection surface create an electric field that enforces a flow profile in the beam that is substantially similar to a reversed Child-Langmuir flow.

According to another aspect of the invention, there is provided a method of forming a charged-particle beam control system. The method includes forming a plurality of external magnets that generate an axially-varying longitudinal magnetic (AVLM)/axially-varying quadrupole magnetic (AVQM) field. Also, the method includes forming a plurality of external electrode geometries generate an axially-varying longitudinal electrostatic (AVLE)/axially-varying quadrupole electrostatic (AVQE) field. The external electrode geometries and magnets control and confine a charged-particle beam of elliptic cross-section. Finally, the method includes forming a depressed collector for a charged-particle beam. The method includes providing one or more electrodes, and forming a collection surface onto which a beam impacts. The electrodes and collection surface create an electric field that enforces a flow profile in the beam that is substantially similar to a reversed Child-Langmuir flow.

### BRIEF DESCRIPTION OF THE DRAWINGS

FIG. 1 is a schematic diagram of a controlled transport system for an elliptic charged-particle beam;

FIG. 2 is a graph illustrating a beam envelope semi-major and semi-minor axis;

FIG. 3 is a 3D Omnitrak simulation of the 6:1 elliptic beam over 2 longitudinal magnetic periods;

FIG. 4 is a schematic diagram of a set of longitudinal field magnets used in a control system for parallel transport of an elliptic charged-particle beam;

FIG. 5 is a schematic diagram of quadrupole field magnets used in a control system for parallel transport of an elliptic charged-particle beam;

FIG. 6 is a schematic diagram of a beam tunnel geometry in an elliptic beam control system;

FIG. 7 is a graph of the on-axis electrostatic potential Φ₀₀(z), the Child-Langmuir potential Φ∝z^{4/3}, and the on-axis potential in the beam transport tunnel Φ₀₀≅−70V versus the axial coordinate z;

FIG. 8 is a graph of an axially-varying magnetic (AVLM) field versus the axial coordinate z over four periods;

FIG. 9 is a graph illustrating an axially-varying quadrupole magnetic (AVQM) field versus the axial coordinate z over four axial magnetic periods;

FIG. 10 is a graph illustrating a beam envelope semi-major axis α and semi-minor axis b of the 6:1 elliptic beam over four longitudinal magnetic periods;

FIG. 11 is a 3D OMNITRAK simulation illustrating a perspective view of particle trajectories over four axial magnetic periods;

FIG. 12 is a schematic diagram of a system of magnets used to generate an AVLM field for matching an elliptic charged-particle beam;

FIG. 13 is a schematic diagram of a system of magnets used to generate an AVQM field for matching an elliptic charged-particle beam;

FIG. 14 is an Omnitrak 3D simulation for a compact, high-efficiency depressed collector;

FIG. 15 is graph illustrating an axially-varying longitudinal magnetic (AVLM) field versus the axial coordinate z over 10 periods;

FIG. 16 is graph illustrating an axially-varying quadrupole magnetic (AVQM) field versus the axial coordinate z over 10 axial magnetic periods; and

FIG. 17 is a Omnitrak 3D simulation result for a 6:1 elliptic charged-particle beam undergoing area compression.

### DETAILED DESCRIPTION OF THE INVENTION

The invention includes a controlled transport system and a compact, high-efficiency depressed collector for an elliptic charged-particle beam system.

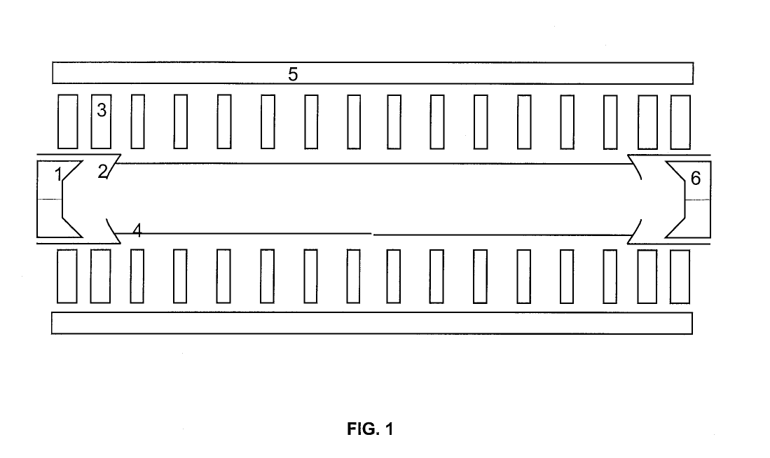

FIG. 1 shows a controlled transport system for an elliptic beam used in accordance with the invention, having a charged-particle emitter 1, an electrode geometry 2 that generates an axially-varying longitudinal magnetic (AVLM) field/an axially-varying quadrupole electrostatic (AVQE) field that accelerates and focuses the beam, a beam tunnel 4, magnets 3 arranged to produce an AVLM field, magnets 5 arranged to produce an axially-varying quadrupole magnetic (AVQM) field, and a depressed collector with electrode geometry 6 that generates an axially-varying longitudinal electrostatic (AVLE) field/AVQE field that decelerates and focuses the beam.

The controlled transport system confines an accelerating elliptic beam of uniform density, and the characteristics of the controlled transport system are obtained by solving a matrix differential equation describing the evolution of the particle distribution function within the beam. The theory of the matrix differential equation includes self-electric and self-magnetic field effects in the beam, emittance effects in the beam, image charge effects from a conducting boundary, the effects of an accelerating or a decelerating electrostatic potential on the beam, and the effects of an AVLM/AVQM focusing field. Solutions are obtained through numerical integration of the matrix differential equation of motion, and the results show that the beam edges in both transverse directions are well confined, while the inclination angle of the beam ellipse can be made vanishingly small. Three-dimensional (3D) trajectory simulations with the commercial Omnitrak code show good agreement with the predictions of matrix theory well as beam stability.

In the paraxial approximation, the evolution of the particle distribution describing the beam is governed by the matrix differential equation

$$\frac{d {M}_{\underline{\_}}}{d z} = {F}_{\underline{\_}} \cdot {M}_{\underline{\_}} + {M}_{\underline{\_}} \cdot {{F}_{\underline{\_}}}^{T} , \qquad ( 1 )$$

where the superscript “T” denotes the transpose operation of a matrix,

$$\begin{matrix}{M}_{\underline{\_}} = ( \begin{matrix}{M}_{xx} & {M}_{{xp}_{x}} & {M}_{xy} & {M}_{{xp}_{y}} \\ {M}_{{p}_{x} x} & {M}_{{p}_{x} {p}_{x}} & {M}_{{p}_{x} y} & {M}_{{p}_{x} {p}_{y}} \\ {M}_{yx} & {M}_{{yp}_{x}} & {M}_{yy} & {M}_{{yp}_{y}} \\ {M}_{{p}_{y} x} & {M}_{{p}_{y} {p}_{x}} & {M}_{{p}_{y} y} & {M}_{{p}_{y} {p}_{y}}\end{matrix} ) , & ( 2 ) \\ and & \\ {F}_{\underline{\_}} ≡ ( \begin{matrix}0 & {F}_{{xp}_{x}} & 0 & 0 \\ {F}_{{p}_{x} x} & 0 & {F}_{{p}_{x} y} & {F}_{{p}_{x} {p}_{y}} \\ 0 & 0 & 0 & {F}_{{yp}_{y}} \\ {F}_{{p}_{y} x} & {F}_{{p}_{y} {p}_{x}} & {F}_{{p}_{y} y} & 0\end{matrix} ) . & ( 3 )\end{matrix}$$

The symmetric matrix M fully defines the hyperellipsoid of the transverse phase-space distribution of the particle beam through the equation

$$\begin{matrix}{\underline{χ}}^{T} \cdot {{M}_{\underline{\_}}}^{- 1} \cdot \underline{χ} = 1 , & ( 4 ) \\ where & \\ \underline{χ} ( z ) ≡ ( \begin{matrix}x \\ {p}_{x} \\ y \\ {p}_{y}\end{matrix} ) , & ( 5 )\end{matrix}$$

and the elements of χ are the usual Cartesian transverse coordinates and momenta.

The elements of the matrix F are

$$\begin{matrix}{F}_{{xp}_{x}} = {F}_{{yp}_{y}} = \frac{1}{γβ m c} , & ( 6 ) \\ {F}_{{p}_{x} x} = q [ - \frac{2}{β c} {Φ}_{20} - \frac{1}{c} ( \frac{{B}_{Q}}{λ} - 2 {βΦ}_{20}^{ρ0} ) ] , & ( 7 ) \\ {F}_{{p}_{x} y} = q [ - \frac{1}{β c} {Φ}_{11} + \frac{1}{c} ( {βΦ}_{11}^{ρ0} + \frac{d {B}_{z}}{d z} ( 1 - {r}_{m} ) ) ] , & ( 8 ) \\ {F}_{{p}_{y} x} = q [ - \frac{1}{β c} {Φ}_{11} + \frac{1}{c} ( {βΦ}_{11}^{ρ0} - \frac{d {B}_{z}}{d z} {r}_{m} ) ] , & ( 9 ) \\ {F}_{{p}_{y} y} = q [ - \frac{2}{β c} {Φ}_{02} + \frac{1}{c} ( \frac{{B}_{Q}}{λ} + 2 {βΦ}_{02}^{ρ0} ) ] , & ( 10 ) \\ and & \\ {F}_{{p}_{x} {p}_{y}} = - {F}_{{p}_{y} {p}_{x}} = \frac{q {B}_{z}}{γβ m {c}^{2}} , & ( 11 )\end{matrix}$$

where v_{z} is the axial beam velocity, β=v_{z}/c, γ²=(1−β²)⁻¹, m and q are the particle mass and charge, respectively, and c is the speed of light in vacuum.

The AVLM field, included in the expressions for the elements of the matrix F through the term B_{z}(z), is primarily a longitudinal field, although it has transverse components which depend linearly on transverse displacements from the axis of symmetry. The AVLM field can be achieved through well-understood means. Electromagnet and permanent magnet solenoids and non-axisymmetric periodic cusped fields using permanent or electromagnet configurations have been described elsewhere. Most simply, a set of axially-magnetized magnets with irises would be used to construct the desired field. The iris shapes and magnet thicknesses, positions, and magnetizations will determine the axially-varying field strength and aspect ratio rₘ/(1−rₘ). As the configuration becomes more elongated, rₘ approaches zero. As the configuration becomes more circular, rₘ, approaches ½.

The AVQM field is represented by the term B_{Q} (z). The parameter 2 which appears in conjunction with B_{Q} (z) is simply an arbitrary scale parameter included for normalization purposes. The application of quadrupole magnetic fields is well understood. Electromagnets with hyperbolically machined iron pole-pieces are often used when strong fields are desired. For weaker fields, permanent magnets of a variety of simple configurations can be used by noting that a quadrupole field is naturally achieved in the region between two oppositely oriented dipole magnets located some distance apart. One might use a single contiguous magnet on either side of the beam or a plurality of magnets chosen to produce the desired field in the beam area.

Together, the applied magnetic fields take the form

$${B}_{app} = {B}_{z} ( z ) {\hat{e}}_{z} - \frac{d {B}_{z} ( z )}{d z} [ {r}_{m} x {\hat{e}}_{x} + ( 1 - {r}_{m} ) y {\hat{e}}_{y} ] + \frac{{B}_{Q} ( z )}{λ} ( y {\hat{e}}_{x} + x {\hat{e}}_{y} ) , \qquad ( 12 )$$

where one can chose a set of Cartesian axes to be aligned with the AVLM field.

The AVLE/AVQE fields are embedded in the expressions for the elements of the Matrix F through the electrostatic potential terms χ. More explicitly, the relations

χ₂₀=χ₂₀^{ρ}+χ_{Q}, (13)

χ₀₂=χ₀₂^{ρ}−χ_{Q}, (14)

χ₁₁=χ₁^{ρ}+χ_{Q} tan 2θ_{Q}, (15)

and note that

$$\begin{matrix}{Φ}_{20}^{ρ} = - \frac{a + b - ( a - b ) cos 2 θ}{4 ( a + b )} ( \frac{4 I}{abc} \frac{1}{\sqrt{1 - {( {γ}_{0} - \frac{q {Φ}_{00}}{m {c}^{2}} )}^{- 2}}} + \frac{{d}^{2} {Φ}_{00}}{d {z}^{2}} ) , & ( 16 ) \\ {Φ}_{02}^{ρ} = ( - 1 + \frac{2 ( a + b )}{a + b - ( a - b ) cos 2 θ} ) {Φ}_{20}^{ρ} , & ( 17 ) \\ {Φ}_{11}^{ρ} = \frac{- 2 ( a - b ) sin 2 θ}{a + b - ( a - b ) cos 2 θ} {Φ}_{20}^{ρ} & ( 18 )\end{matrix}$$

where a(z) is the semi-major axis of the elliptic beam, b(z) is the semi-minor axis of the elliptic beam, θ(z) is the inclination angle of the semi-major axis of the elliptic beam with respect to the laboratory Cartesian x-axis, I is the beam current, Φ₀₀(z) is the axial electrostatic potential (generating the AVLE field), and γ₀≡γ|_{Φ=}0 is the value taken by the relativistic factor where the axial electrostatic potential vanishes.

The AVQE field is generated by the terms Φ_{Q} (z) and θ_{Q}(z). The Φ_{Q} term represents a quadrupole electric field (rotated by an angle θ_{Q} relative to the χ-axis of the laboratory coordinates) which is imposed by external conducting walls and applied potentials. In order to enforce a particular Φ_{Q} in the beam interior, electrodes at the specified potentials are placed along one or more external equipotential surfaces given by the equation

Φₑₓₜ=Φ₀₀+Φₑₓₜ^{ρ}+Φ_{Q}(x²−y²+xy tan 2θ_{Q}), (19)

where Φₑₓₜ^{ρ}(z) is the external field generated (in vacuum) by the space charge of the elliptic beam. This allows the design of conformal coasting beam tunnels which can aid in beam focusing (setting Φ_{Q}=0 defines the external equipotentials which negate all image-charge effects), or, alternatively, the design of beam tunnels which enforce a desired quadrupole focusing field on the beam. Note also that perturbations of external electrodes from the specified equipotentials will have a diminishing effect with distance from the beam. This last fact ensures that a beam tunnel of almost arbitrary shape, if sufficiently large, will have negligible image-charge effects.

The matrix differential equation description of an accelerating beam along with the general treatment of AVLM/AVQM/AVLE/AVQE fields allows the development of a powerful control system for elliptic charged-particle beams. At any point along an elliptic beam system, if a desired beam profile is specified, the matrix differential equation allows to determine one or more specific configurations of AVLM/AVQM/AVLE/AVQE fields that will maintain the desired profile in a controlled fashion.

As the first example of the control system, one can consider a space-charge-dominated 6:1 elliptic electron beam with desired envelopes semi-axes a_{des}=0.373 cm and b_{des}=0.062 cm propagating with current I=0.11 A along a beam tunnel with a constant axial potential of Φ₀₀=2290 V. (In this case, because the axial potential Φ₀₀ is constant, the AVLE field vanishes.) For this beam, one can have β=0.094 and γ=1.0045, and one can choose a reference length of λ=b_{des}. One may take, for definiteness, an oscillatory form for B_{z} such as

$${B}_{z} ( z ) = {B}_{0} sin ( \frac{2 π z}{S} ) , \qquad ( 20 )$$

where the period S=1.912 cm, and the field aspect ratio parameter rₘ=0.02.

In this case, symmetry properties of the matrix differential equation imply that, in an equilibrium beam solution with parallel transport, all transverse beam velocities will vanish in the planes z=z nS, where n is an integer. In any of these planes at z=2 nS all of the distribution matrix elements vanish, except Mₓₓ, M_{yy}, and M_{xy}=M_{yx}. One can search for a matched solution by integrating the matrix differential equation over ½, a period of the longitudinal magnetic field and applying periodicity and parity constraints at either end of the integration interval, i.e.,

$${M}_{xx} ( z = \frac{n}{2} S ) = {M}_{xx} ( z = \frac{n + 1}{2} S ) , \\ {M}_{yy} ( z = \frac{n}{2} S ) = {M}_{yy} ( z = \frac{n + 1}{2} S ) , and$$

$${M}_{xy} ( z = \frac{n}{2} S ) = - {M}_{xy} ( z = \frac{n + 1}{2} S ) .$$

This process yields an AVQM/AVQE field of

$$( {B}_{Q} + \frac{{Φ}_{Q}}{β} ) = - 1.9 G , \qquad ( 21 )$$

and an AVLM field of

B₀=−260G. (22)

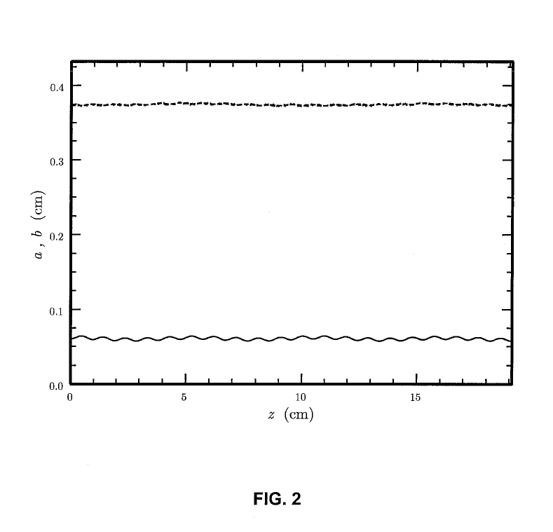

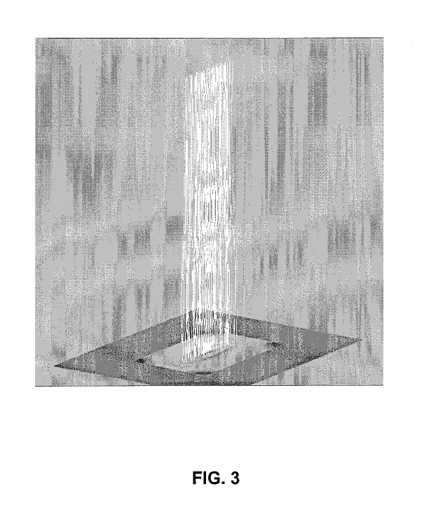

Note that the quadrupole AVQM/AVQE fields are only jointly determined. This allows a great deal of freedom in fixing either the AVQM or the AVQE as per our convenience and then allowing the other to be determined by the result of the matrix differential equation. In the example case at hand, one can choose Φ_{Q}=0 for convenience by locating the conducting walls around the beam system such that they are far-removed from the beam. As seen in FIG. 2, which is the result of an integration of the matrix differential equation using the prescribed AVQM/AVQE/AVLM field over 10 magnetic periods, the beam semi-axes are well-controlled. An independent confirmation of the well-controlled beam is provided by a 3D OMNITRAK self-consistent particle trajectory simulation, the results of which are seen in FIG. 3.

There exists a critical value of the AVLM field aspect ratio parameter rₘ=r_{crit} for which the amplitude of the beam envelope twist angle θ approaches its minimum value. The precise value of the critical field aspect ratio parameter can be obtained through integration of the matrix differential equation, however, an approximate value can be obtained through a perturbation analysis of the matrix differential equation, which yields r_{crit}=b_{des}²/a_{des}². In the example discussed above, the chosen value of the field aspect ratio parameter rₘ=0.02 is close to r_{crit}, and thus the amplitude of the beam envelope twist angle is negligible.

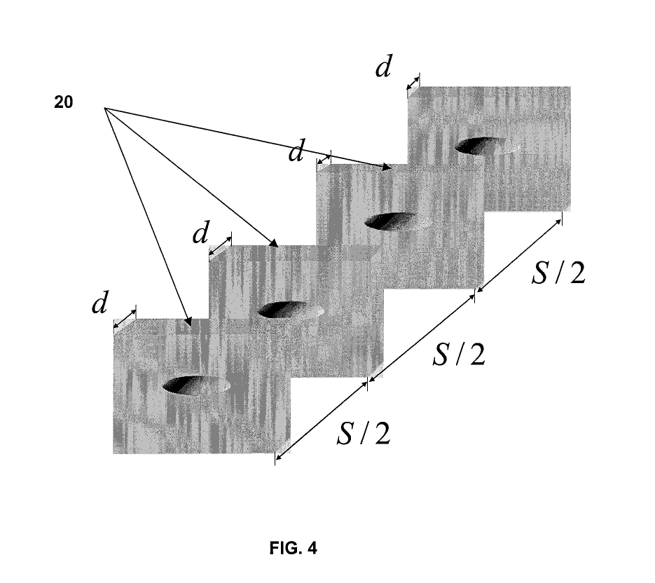

The realization of the prescribed AVLM field is a set of axially-magnetized permanent magnets 20 with alternating magnetization polarities separated by an axial distance S/2, as shown in FIG. 4. The magnet thicknesses, iris dimensions, and outer boundaries are chosen so as to obtain the axially-varying field strength and aspect ratio parameter rₘ prescribed by the results of the integration of the matrix differential equation. Note that each magnet 20 need not be a contiguous piece, as various magnet sections may be assembled to accomplish the same effect. Note also that pole pieces may be used to shape and direct the field in order to enhance the fidelity of the near-axis field profile to the desired form.

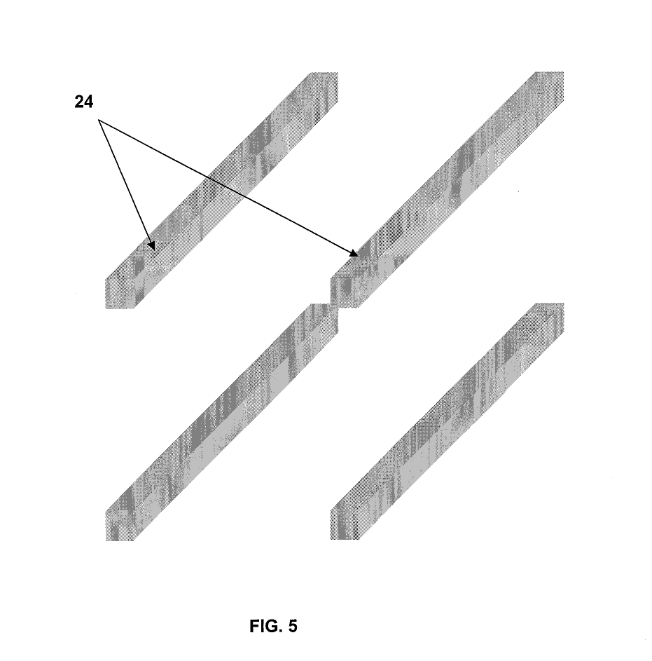

Also, the AVQM field can make use a single contiguous magnet on either side of the beam or a plurality of magnets 24 chosen to produce the same effect, as shown in FIG. 5. Note, again, that pole pieces 24 may be used in order to further control the field generated by the magnets.

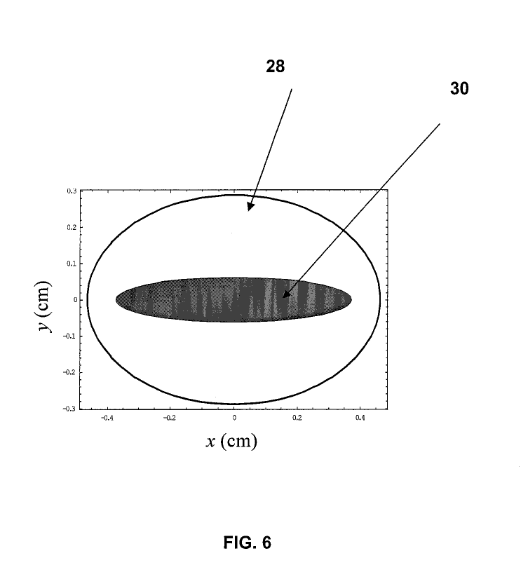

An alternate embodiment replaces the AVQM field by an AVQE field. The AVQE field is generated by appropriate shaping of the beam tunnel 28 confining the elliptic beam 30, such as in the configuration shown in FIG. 6.

Another alternate embodiment includes some intermediate combination including both AVQM and AVQE fields obtained through shaping of the beam tunnel and application of quadrupole magnets.

In another embodiment of the control system, one can consider the matching of a 6:1 elliptic electron beam of constant envelope semi-axes a_{des}=0.373 cm and b_{des}=0.062 cm propagating with current I=0.11 A. The beam is emitted from a space-charge-limited, parallel-flow, elliptic electron diode with diode length d=0.411 cm and cathode potential Φ₀₀(0)=−2290 V. It is injected into a grounded, rectangular beam tunnel of width 10.74 mm and height 7.0 mm.

Again, for definiteness, one can choose an oscillatory form for B_{z} with a slowly-varying envelope, such as

$${B}_{z} ( z ) = {B}_{0} ( z ) sin ( \frac{2 π z}{S} + ϕ ) , \qquad ( 23 )$$

where the period S=1.0 cm, and the field aspect ratio parameter rₘ=0. A reference length of λ=b_{des} is chosen. The phase shift φ is an additional control parameter that is introduced in the system. The formalism, in general, allows for any number of additional parameters to be used in the field representations.

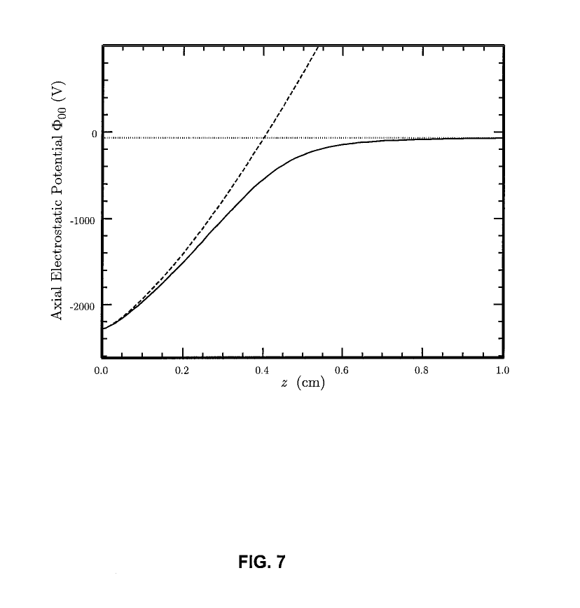

The differential matrix equation can again be solved to obtain a combination of AVLM/AVQM/AVLE/AVQE fields that is self-consistent with a well-controlled beam. For the example case, the AVLE is fixed by an electrostatic potential Φ₀₀(z) that smoothly varies from the Child-Langmuir form near the emitter to a constant value of Φ₀₀≅−70 V in the beam tunnel, as shown in FIG. 7.

The AVQE is made to vanish by the appropriate choice of the electrode geometry external to the beam (e.g., by having a large beam tunnel).

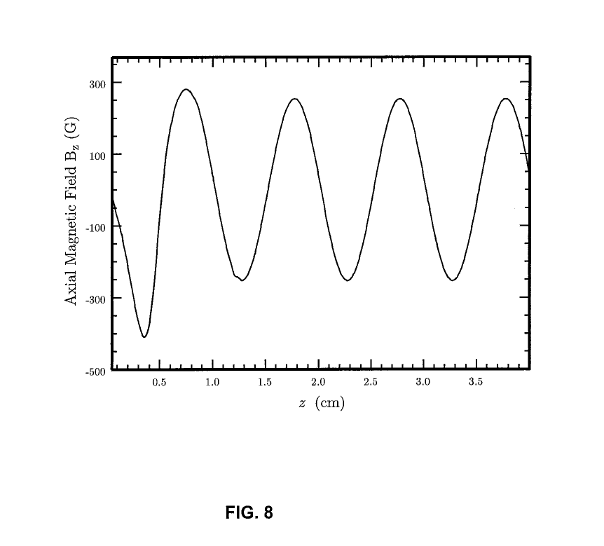

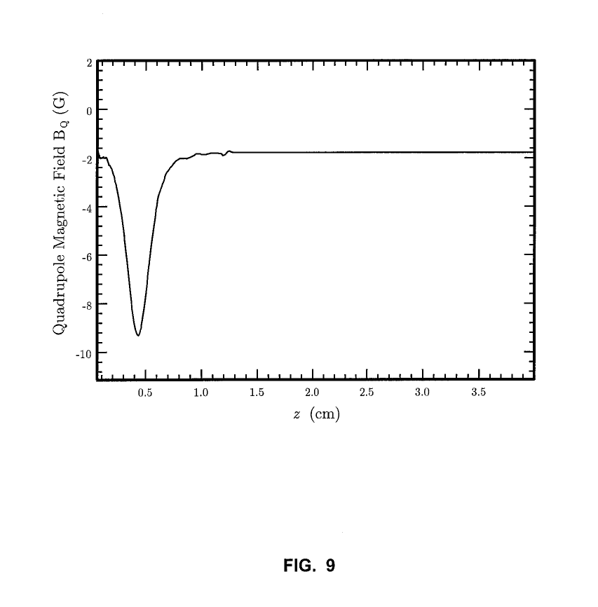

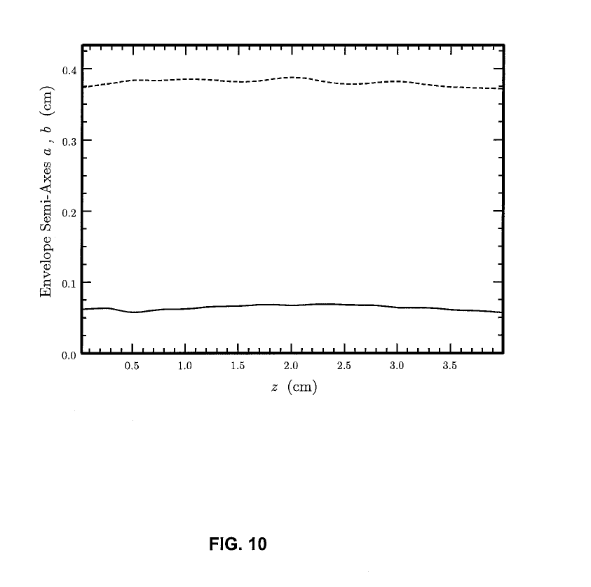

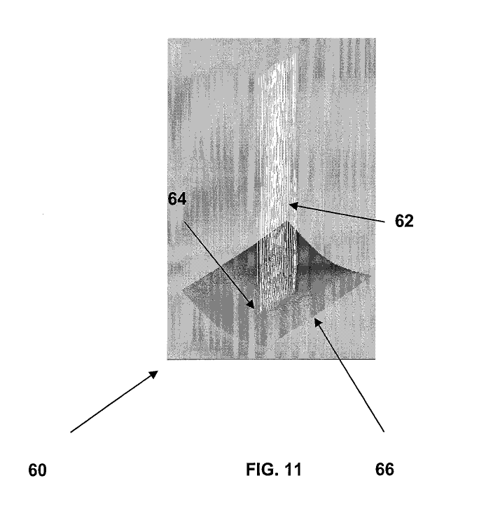

The AVLM and AVQM are then determined by the matrix differential equation to take the forms shown in FIG. 8 and FIG. 9, respectively, with a choice of φ=−0.16 for the phase shift parameter. As seen in FIG. 10, which is the result of an integration of the matrix differential equation using the prescribed AVQM/AVQE/AVLM/AVLE field over 4 longitudinal magnetic periods, the beam semi-axes are well-controlled. An independent confirmation of the well-controlled beam is provided by a 3D OMNITRAK self-consistent particle trajectory simulation, the results of which are seen in FIG. 11.

An AVLE field can be formed using a modified elliptic beam Child-Langmuir diode 60. The electrode shapes are determined by the conditions necessary to obtain a Child-Langmuir beam 62, with the modification that an aperture 64 is created at the collector plate 66 in order to extract the beam into the beam tunnel. The collection surface onto which the a beam impacts wherein said electrodes and collection surface create an electric field that enforce a flow profile in the beam that is substantially similar to a reversed Child-Langmuir flow.

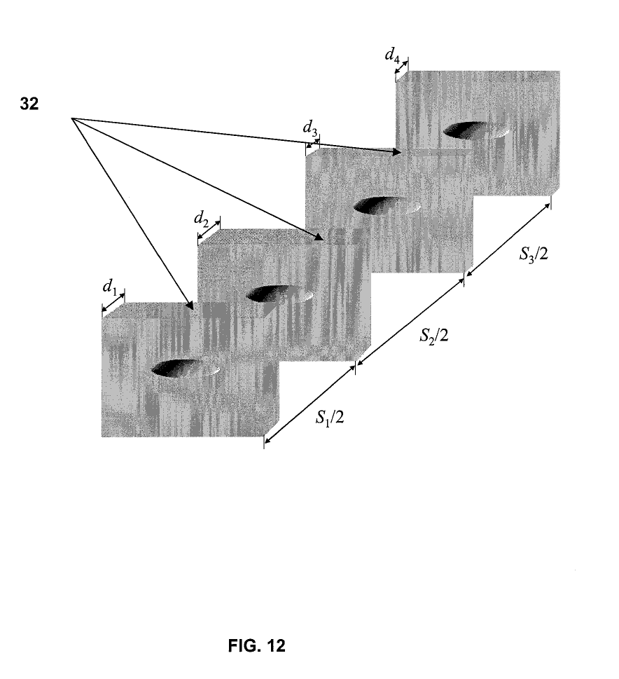

A set of axially-magnetized permanent magnets 32 with alternating magnetization polarities can be used to form AVLM, as shown in FIG. 12. The magnet thicknesses, iris dimensions, and outer boundaries are chosen so as to obtain the axially-varying field strength and aspect ratio parameter rₘ prescribed by the results of the integration of the matrix differential equation. Note that each magnet need not be a contiguous piece, as various magnet sections may be assembled to accomplish the same effect. Note also that pole pieces can be used to shape and direct the field in order to enhance the fidelity of the near-axis field profile to the desired form and have varying diameters.

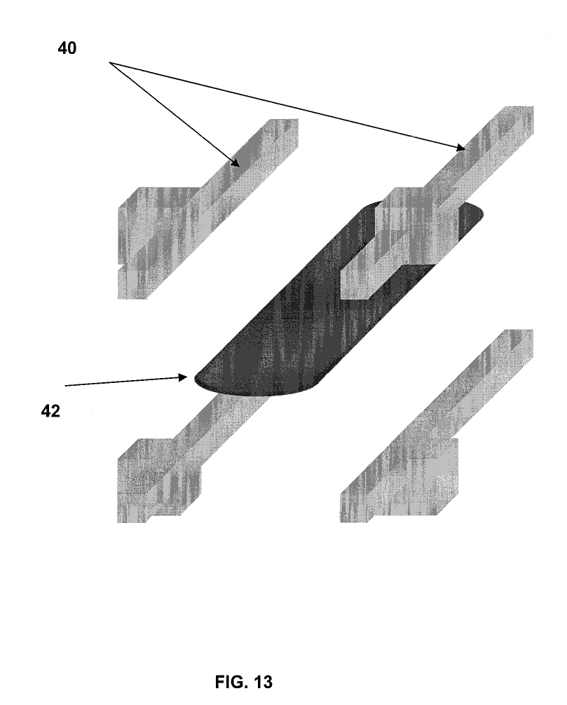

A set of quadrupole magnets 40 placed on the sides of a beam 42 is used to form an AVQM field, as shown in FIG. 13. Some combination of increase in magnet size, increase in magnet strength, or variation of magnet placement can be used to construct the peak in the magnitude of the desired AVQM field. Note, again, that pole pieces can be used in order to further control the field generated by the magnets.

Another alternate embodiment includes some combination including both AVQM and AVQE fields obtained through shaping of the beam tunnel, shaping of the aperture connection the elliptic beam diode and transport section, and application of quadrupole magnets.

In a third embodiment of the control system, the matching of a 6:1 elliptic electron beam of constant envelope semi-axes a_{des}=0.373 cm and b_{des}=0.062 cm propagating with current I=0.11 A is considered. The beam is traveling through a grounded, rectangular beam tunnel of width 10.74 mm and height 7.0 mm, and is then collected on a compact, high-efficiency depressed collector. This configuration can be constructed precisely as the inverse of the second example considered, and as such, the depressed collector can be constructed as a reversed Child-Langmuir beam-emitting diode and the AVLM/AVQM/AVLE/AVQE fields determined using the methods discussed in the second example in order to obtain a well-controlled beam solution.

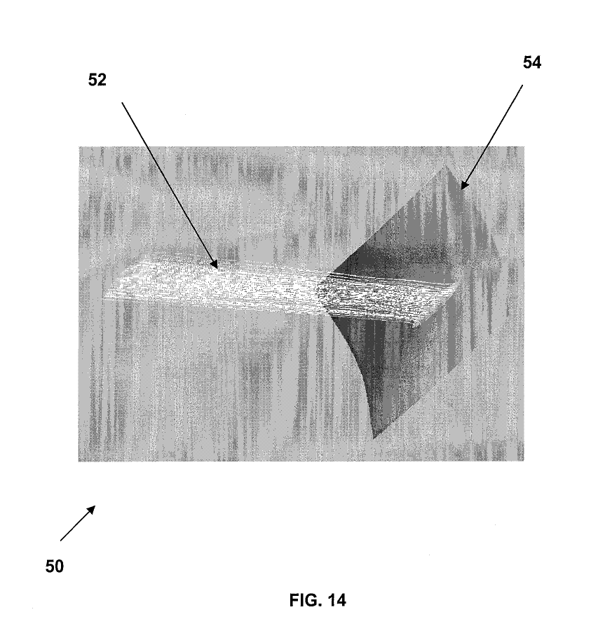

In practice, thermal noise and beam focusing errors will increase beam emittance such that it is impossible to fully recover the initial injection energy from a beam. As a result, it will be necessary to impose minor potential or geometry modifications on the depressed collector such that it is not a true mirror-image of the beam emitting diode. FIG. 14 shows a compact, high-efficiency depressed collector 50 designed to collect the beam 52 on a collection surface 54 onto which a beam impacts emitted from the space-charge-limited, parallel-flow, elliptic electron diode the second example with cathode potential Φ₀₀(0)=−2290 V. The depressed collector potential Φ_{coll} can be set to greater than 99.5% of the emitter potential value (i.e., to a potential less than Φ_{coll}=−2279 V), before reflected particles are observed in the OMNITRAK simulation of FIG. 14, implying that the efficiency of this compact, single-stage depressed collector is greater than 99.5%. As a fourth example of the control system, the compression of a space-charge-dominated 6:1 elliptic electron beam propagating with current I=0.11 A along a beam tunnel with a constant axial potential of Φ₀₀=2290 V is considered. In this case, because the axial potential Φ₀₀ is constant, the AVLE field vanishes. For this beam, one can have β=0.094 and γ=1.0045, and a reference length of λ=0.062 cm is selected. The beam undergoes compression by an area factor of 4, and the desired forms of the elliptical semi-axes are given by

$$\begin{matrix}{a}_{des} ( z ) = {a}_{f} [ \frac{3}{2} - \frac{1}{2} tanh ( \frac{2 z}{3 S} - 3 ) ] , & ( 24 ) \\ {b}_{des} ( z ) = {b}_{f} [ \frac{3}{2} - \frac{1}{2} tanh ( \frac{2 z}{3 S} - 3 ) ] , & ( 25 )\end{matrix}$$

where a_{f}=0.187 cm, b_{f}=0.031 cm, and a longitudinal magnetic period of length
S=1 cm is selected for an AVLM field of the form

$${B}_{z} ( z ) = {B}_{0} ( z ) sin ( \frac{2 π z}{S} ) . \qquad ( 26 )$$

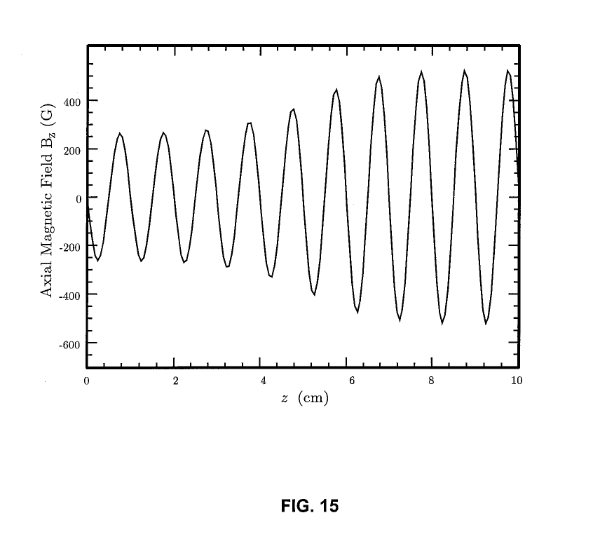

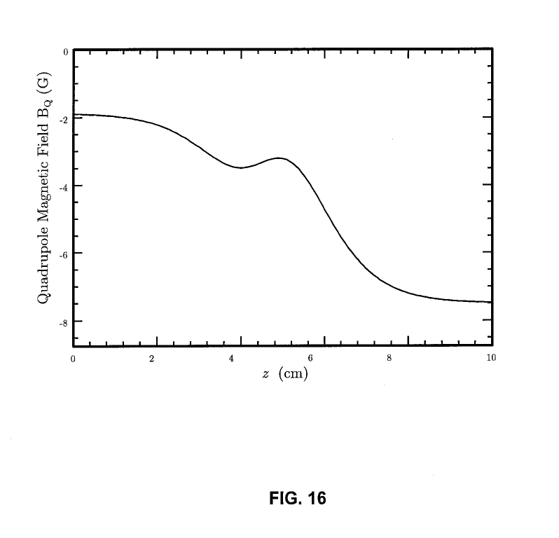

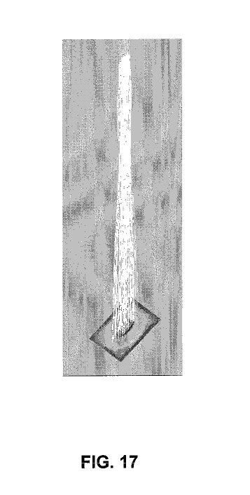

The AVLM and AVQM fields are then determined by the matrix differential equation to take the forms shown in FIG. 15 and FIG. 16, respectively. As seen in FIG. 17, which is the result of an integration of the matrix differential equation using the prescribed AVQM/AVQE/AVLM/AVLE field over 10 longitudinal magnetic periods, the beam semi-axes are well-controlled and closely follow the desired forms. An independent confirmation of the well-controlled beam is provided by a 3D OMNITRAK self-consistent particle trajectory simulation, the results of which are seen in FIG. 17. Note that additional parameters, such as a phase shift, can be introduced into the field representations used for beam compression in order to obtain even finer control over the beam. In addition, note that a completely analogous procedure can be followed to obtain the fields required for beam expansion or to obtain the fields required for compression by a different compression factor.

Although the present invention has been shown and described with respect to several preferred embodiments thereof, various changes, omissions and additions to the form and detail thereof, may be made therein, without departing from the spirit and scope of the invention.

What is claimed is:

1. A charged-particle beam control system comprising:
a plurality of external magnets that generate an axially-varying longitudinal magnetic (AVLM)/axially-varying quadrupole magnetic (AVQM) field;
a plurality of external electrode geometries that generate an axially-varying longitudinal electrostatic (AVLE)/axially-varying quadrupole electrostatic (AVQE) field; wherein said external electrode geometries and magnets control and confine a charged-particle beam of elliptic cross-section; and
a depressed collector that collects the charged-particle beam.

2. The charged-particle beam control system of claim 1, wherein the AVLM field aspect ratio parameter takes the critical value rₘ=r_{crit} such that the magnitude of the beam envelope twist angle θ approaches its minimum value.

3. The charged-particle beam control system of claim 2, wherein the AVLM field aspect ratio parameter rₘ takes a value greater than 0.01 r_{crit} and less than 100 r_{crit}.

4. The charged-particle beam control system of claim 1, wherein the external magnets and electrode geometries enforce laminar flow of the beam from emission, through a charged-particle diode, and into a beam transport tunnel.

5. The charged-particle beam control system of claim 1, wherein the external magnets and electrode geometry enforce compression of the charged-particle beam.

6. The charged-particle beam control system of claim 6, wherein the area expansion factor is greater than 1.01 and less than 10000.

7. The charged-particle beam control system of claim 1, wherein the depressed collector for a charged-particle beam comprising:
one or more electrodes; and
a collection surface onto which a beam impacts wherein said electrodes and collection surface create an electric field that enforce a flow profile in the beam that is substantially similar to a reversed Child-Langmuir flow.

8. The depressed collector of claim 7, wherein said charged-particle beam possesses an elliptic cross-section.

9. The depressed collector of claim 7, wherein said charged-particle beam possesses a uniform transverse density profile.

10. The depressed collector of claim 9, wherein the collector efficiency exceeds 90%.

11. A method of forming a charged-particle beam control system comprising:
forming a plurality of external magnets that generate an axially-varying longitudinal magnetic (AVLM)/axially-varying quadrupole magnetic (AVQM) field;
forming a plurality of external electrode geometries that generate an axially-varying longitudinal electrostatic (AVLE)/axially-varying quadrupole electrostatic (AVQE) field, wherein said external electrode geometries and magnets control and confine a charged-particle beam of elliptic cross-section; and
forming a depressed collector that collects the charged-particle beam.

12. The method of claim 11, wherein the AVLM field aspect ratio parameter takes the critical value rₘ=r_{crit} such that the magnitude of the beam envelope twist angle θ approaches its minimum value.

13. The method of claim 12, wherein the AVLM field aspect ratio parameter rₘ takes a value greater than 0.01 r_{crit} and less than 100 r_{crit}.

14. The method of claim 11, wherein the external magnets and electrode geometries enforce laminar flow of the beam from emission, through a charged-particle diode, and into a beam transport tunnel.

15. The method of claim 11, wherein the external magnets and electrode geometry enforce compression of the charged-particle beam.

16. The method of claim 16, wherein the area expansion factor is greater than 1.01 and less than 10000.

17. The method of claim 11, wherein the method of forming a depressed collector for a charged-particle beam comprising:
providing one or more electrodes; and
forming a collection surface onto which the a beam impacts wherein said electrodes and collection surface create an electric field that enforce a flow profile in the beam that is substantially similar to a reversed Child-Langmuir flow.

18. The depressed collector of claim 17, wherein said charged-particle beam possesses an elliptic cross-section.

19. The depressed collector of claim 17, wherein said charged-particle beam possesses a uniform transverse density profile.

20. The depressed collector of claim 19, wherein the collector efficiency exceeds 90%.
